(19) United States
(12) Patent Application Publication
(10) Pub. No.: US 2006/0224441 A1
(43) Pub. Date: Oct. 5, 2006

(54) Method and system for improving quality in a service industry

(76) Inventors: Sanjiv Kerkar, Mumbai (IN); Debashis Sarkar, Mumbai (IN)

Correspondence Address: KNOBBE MARTENS OLSON & BEAR LLP, 2040 MAIN STREET, FOURTEENTH FLOOR, IRVINE, CA, 92614, US

(21) Appl. No.: 11/300,752

(22) Filed: Dec. 14, 2005

(30) Foreign Application Priority Data
Mar. 30, 2005 (IN) INDIA374/MUM/2005

(51) Int. Cl. G06Q 99/00; G06F 15/02; G07G 1/00; G06F 9/46; H04M 3/51

(52) U.S. Cl. 705/11; 705/1; 705/9; 705/10

(57) ABSTRACT

A system and method for improving quality. In one embodiment, the system includes an electronic device for classifying an organization into one of a plurality of hierarchical quality service levels. Each of the levels has associated attributes that should be satisfied before an organization proceeds to evaluate the next level.

### BACKGROUND OF THE INVENTION

1. Field of the Invention

The present invention relates to the field of implementing quality improvements in a service sector undertaking. More particularly the invention relates to a comprehensive framework that can be implemented in a service-based industry/organizations/undertaking for its continual improvement.

2. Description of the Related Technology

All service sector undertakings strive to deliver the best to their customers. In order to be in the market they not only need to introduce new concepts, ideas and products into the market but also improve upon the quality of the existing products (includes services), processes and systems.

In a manufacturing company, if products do not meet the specifications there is always an opportunity to correct/rework them before they are dispatched to the marketplace. In service organizations, this is not possible. The production and consumption of service typically happens at the same time. In case of service companies, not only should the service offering be of satisfactory quality, the interaction between the representative of the organization and customer should be flawless. This is true for service companies such as banks, consultancies, shopping arcades, hotels, supermarkets etc. The focus of service companies is essentially about selling an experience. It requires meeting the requirements of the end users with an objective to improve the customer satisfaction levels and engage in a long term happy and growing relationship.

Service organizations have aspirations to become “world-class.” Different “equality methodologies” focus on different aspects of quality improvement. While some focus on workplace problems, others are targeted towards enterprise-wide deployment. Some are meant for facilitating improvements through daily management while others are meant for large process improvements. While each methodology provides value from its perspective, none of them generally provide a holistic value to aid an organization to become world-class.

The current approach taken by organizations is to adopt a quality methodology that is prevalent, easily available and popular. For example, companies are currently adopting Six Sigma, as it is the current flavor in the domain of improvements. This decision is taken in isolation without clearly understanding relevance and need. There is no method that assists in such decision making. Often consultants offer the methodology that they are conversant with. This is like convincing a company to adopt ISO when the need was for Lean Thinking. For some organizations, the Quality Methodology is imposed by their customers as in the case of Software and Business Process Outsourcing Businesses e.g. CMM, COPC, BS 7799, etc.

The results of these approaches are that the quality journey becomes methodology centric and does not cater to the larger objective of the organization to become world-class. Even if each of these methodologies provides some value-add, they certainly do not necessarily steer the company to be the world class.

It has been observed, especially in large undertakings, that a lack of a common approach to improvements can at times be quite counter-productive. Some units within the organization adopt their own methodologies, which while adding incremental value to the unit, do not add up to deliver the overall objective of the organization to become world class.

Further, an organization typically cannot achieve world class performance by adopting a single quality methodology. A journey to world class level is achieved by leveraging the power of various quality methodologies over a period of time. This requires managing each of phases of these quality methodologies viz. launch, adoption, maturity and decline so that the momentum of improvements can be kept on without sliding back. Organizations should understand the various stages of improving quality and take proactive steps before any initiative stagnates and declines, leading to an improvement vacuum i.e. a stage when an organization struggles to look for a quality framework, which can keep the momentum of improvements on. During this phase no meaningful improvements happen or improvements just happen as a ritual. Existing quality methodologies stop delivering value to the organization. If immediate steps are not taken, benefits reaped so far may get undone.

Accordingly a method is needed to meet the customer's requirements, offer prompt and quality service, reliability and assurance of service and the like. From the organizational perspective it is desirous to have a framework that can look at areas that need refinement so as to make the internal processes smoother, well defined and better organized. There is a need of an apparatus to let the organization arrive at a decision on the approach to be followed in their journey towards getting into the trajectory of world-class.

### SUMMARY OF CERTAIN INVENTIVE ASPECTS

The system, method, and devices of the invention each have several aspects, no single one of which is solely responsible for its desirable attributes. Without limiting the scope of this invention as expressed by the claims which follow, its more prominent features will now be discussed briefly.

One embodiment comprises a method of improving an organization. The method comprises: classifying an organization into at least one of a plurality of levels in a hierarchy ranging from lower to higher. Said classifying includes measuring the organization against a plurality of attributes at each level. The method also comprises applying one or more of known quality methodologies at each level wherein: for at least one lower level, the methodologies selected, aim at achieving desired physical improvements, for at least one level that is higher than the lower level, the combination of methodologies selected, additionally aim at process improvements at that level, and for the highest level, the combination of methodologies selected aim at achieving customer satisfaction and reduction of defects. In one embodiment, applying comprises determining whether the company meets the attributes of the classified level prior to progressing the company to a higher level.

Another embodiment comprises an apparatus for improving an organization. The system comprises means for classifying an organization into at least one of a plurality of levels in a hierarchy ranging from lower to higher, wherein said classifying includes measuring the organization against a plurality of attributes at each level. The system also comprises means for applying one or more of known quality methodologies at each level wherein: for at least one lower level, the methodologies selected, aim at achieving desired physical improvements, for at least one level that is higher than the lower level, the combination of methodologies selected, additionally aim at process improvements at that level, and for the highest level, the combination of methodologies selected aim at achieving customer satisfaction and reduction of defects, wherein the means for applying determines whether the company meets the attributes of the classified level prior to progressing the company to a higher level.

Yet another embodiment comprises a program storage device storing instructions that when executed performs a method. The method comprises: classifying an organization into at least one of a plurality of levels in a hierarchy ranging from lower to higher. Said classifying includes measuring the organization against a plurality of attributes at each level. The method also comprises applying one or more of known quality methodologies at each level wherein: for at least one lower level, the methodologies selected, aim at achieving desired physical improvements, for at least one level that is higher than the lower level, the combination of methodologies selected, additionally aim at process improvements at that level, and for the highest level, the combination of methodologies selected aim at achieving customer satisfaction and reduction of defects. In one embodiment, applying comprises determining whether the company meets the attributes of the classified level prior to progressing the company to a higher level.

### BRIEF DESCRIPTION OF THE DRAWINGS

FIG. 1 is a diagram showing the relationship between the purpose of a quality system and the interested parties.

FIG. 2 illustrates the quality system funnel for improvements.

FIG. 3 illustrates the difference between continuous and continual improvement scenario.

FIG. 4A shows the PDCA cycle.

FIG. 4B shows implementation of PDCA in a continual improvement environment.

### DETAILED DESCRIPTION OF CERTAIN EMBODIMENTS

The following detailed description is directed to certain specific embodiments of the invention. However, the invention can be embodied in a multitude of different ways as defined and covered by the claims. In this description, reference is made to the drawings wherein like parts are designated with like numerals throughout.

Definitions

Baldrige Award: An award established by US Congress in 1987 to raise awareness of quality management and recognize US companies that have implemented successful quality management system. The criteria include leadership, use of information and analysis, strategic planning, human resources, business process management, financial results and customer focus and satisfaction

Benchmarking: An improvement process in which a company measures its performance against that of best in class companies, determines how those companies achieve the performance levels and uses the information to improve its own performance level.

BS 7799: British commerce, government and industry stakeholders wrote BS 7799 to address information security management issues including fraud, industrial espionage and physical disaster.

Business Process Reengineering: The concentration on the improvement of business processes that will deliver outputs that will achieve results meeting the firm's objectives, priorities and mission

Capability Maturity Model: A framework that describes the key elements of an effective software process. It is an evolutionary improvement path from an immature process to a mature disciplined process. The CMM covers practices for planning, engineering and managing software development and maintenance. When followed these practices improve the ability of the organizations to meet the goals for cost, schedule, functionality and product quality.

Concurrent Engineering: A way to reduce cost, improve quality and shrink cycle time by simplifying a product's system of life cycle tasks during the early concept stages.

Cost of Quality: The practice of finding out costs associated with providing poor quality products or services.

Statistical Quality Control: The application of statistical techniques to control quality.

Supplier Quality Assurance: The approach to quality improvement to build quality into the products and services provided by a supplier.

Taguchi Method: Quality engineering developed by Genichi Taguchi which calls for off-line quality control, on-line quality control and a system or experimental design to improve quality and reduce costs.

Theory of Constraint: It is an approach devised by Goldratt that that examines the entire system for continuous improvement.

TL 9000: A quality management system for telecom industry built on ISO 9000.

Customer Relationship Management: An approach to learn more about customers' needs and behaviors to develop stronger relationships with them.

Deming Prize: Award given annually to organizations that, according to the award guidelines, have successfully implemented company wide quality control based on statistical quality control.

Design of Experiments: A quality tool that deals with planning, conducting, analyzing and interpreting controlled tests to evaluate the factors that control value of a parameter or group of parameters.

Design for Six Sigma: An approach for designing new products or services and is a part of Six Sigma initiative. A data driven methodology for designing new products and services. It is a comprehensive approach that helps to design in the customer requirements to the product or service being offered by an organization. It uses tools such as customer surveys, quality function deployment, failure mode effect analysis etc. The objective is to develop products or services that operate at low defect levels.

Sigma (DMAIC): A data driven quality methodology that targets to improve processes as required by customers.

FS 9100: A quality management standard developed for financial services industry.

Hoshin Planning: A Japanese strategic planning process in which a company develops a vision and works out relevant goals and work plans.

ISO 9000: A family of international quality management standards and guidelines that reflects a global consensus on product or service quality in the international context but can be applied by organizations world wide to their particular situation.

Total Productive Maintenance: A quality approach targeted towards upkeep of machine in a manufacturing company.

Total Quality Control: A system that integrates quality development, maintenance, and improvement of the parts of an organization. It helps a company economically manufacture its product and deliver its services.

Total Quality Management: An approach to build quality an organization enterprise-wide using elements such as; leadership, participation, training, costs and so on.

Value Stream Management: An approach to look at a product family end to end from the time it is conceptualized until it reaches the hand of the customer.

Zero Defects: A quality approach developed by Philip Crosby that states if people commit themselves to watching details and avoiding errors, the can move closer to the goal of zero.

Juran Trilogy: A quality approach developed by Joseph Juran for managing quality which includes quality planning, quality control and quality improvement.

Just in Time: An approach to improvement which ensures optimal planning system for a manufacturing process in which there is little or no inventory on hand at the manufacturing site or no incoming inspection.

Kaizen: A Japanese approach to improvement popularized by Masaki Imai that focuses on doing little things better and achieving higher standards.

Five S: This is a methodology for workplace organization to improve workplace efficiency.

Lean Manufacturing: Initiative focused on eliminating all waste in process to target zero inventories, zero waiting time and continuous flow. MIL-Q-9858A: A military standard requirement that describes quality requirements.

Poka Yoke: A Japanese philosophy of preventing defects from occurring machines.

Process Improvement: The application of PDCA cycle principles to improvement.

SMED: An approach for reducing tool changeover times facilitating increased capacity, smaller batch sizes, lower inventory and reduced lead times

Value Engineering: Value engineering is a functional analysis methodology that identifies and selects the best value alternative for designs, materials, processes, systems, and program documentation.

Pull System: An improvement approach which is an alternative to scheduling individual processes, in which the customer process withdraws the items it needs from a supermarket, and the supplying process produces to replenish what was withdrawn.

Benefit Cost Analysis: An approach that facilitates examination of the relationship between the monetary cost of implementing an improvement and the monetary value of the benefits achieved by the improvement, both within the same time period.

Process Management: The methodology of applying tools and techniques to a process to implement and improve process efficiencies hold the gains and ensure process integrity in fulfilling customer requirements.

Process Performance Management: The overseeing of process instances to ensure their quality and timeliness. This includes both proactive and reactive actions.

QS 9000: A quality management standard developed by the big three automakers the automotive sector.

QEDS Standards: A quality standard developed by US Standards Group on Quality, Environment, Dependability and Statistics.

Quality Circle: An approach to Quality improvement carried out voluntary by small group of by employees.

Quality Engineering: The analysis of a manufacturing system at all stages to maximize the quality of the process itself and the product it produces.

QUEST Standards: A partnership of telecommunication suppliers and service providers with more than 130 members who have developed the quality standard TL 9000 for telecom firms.

Quality Management: Management of all activities through a systematic and determined focus on continual improvement, above minimum levels of performance set by a formal quality management standard.

CoBIT (Control Objectives for Information and related Technology): CoBIT has been developed as a generally applicable and accepted standard for good Information Technology (IT) security and control practices that provides a reference framework for management, users, and IS audit, control and security practitioners.

Quality Roadmap

One embodiment includes a ready roadmap which can be adopted by service organizations striving to be world class. The roadmap provides a path and a ladder which a company needs to climb to creates processes that provide superior customer experience. Experiences show that, for most companies, reaching world class is often a mirage. This approach gives a ready recipe to reach the end state, which is normally a struggle for many organizations. The roadmap has been optimized into four steps which facilitates top management to ascertain progress on a regular basis. The traits of each of the levels act as dashboards for the Chief Executive Officer and other senior management to ascertain and monitor progress vis a vis the company's larger objectives of world class. The Business Transformation Model also provides a unique platform to manage multiple quality methodologies while ensuring they do not work at cross-purposes. The quality roadmap is designed in such a fashion that it touches all facets of an organization comprising physical workplace, processes, people, customer, business strategy, leadership, vendors etc. The Business Transformation is just not a roadmap but an approach to improve the way an organization does business and endeavors to build this up through the levels of hierarchy discussed in detail later.

Methodology versus Framework

Throughout the document, the terms “methodology” and “framework” will appear at a number of places. The former refers to standards, improvement methodologies and excellence models as listed in Table 1 that has a variety of origins. While the latter, i.e., “framework” refers to a holistic and integrated approach carved out of medley of methodology to actively facilitate business improvement. The Business Transformation Model, which is the subject of this document, is such a framework.

It may be noted that the genesis of “methodologies” relates to the work done by eminent practitioners or standards issued by standard setting bodies. Some of these methodology are generic in nature while others are meant for specific types of businesses. Quality framework here means a medley of methodologies put together holistically to achieve the status of world class.

In order to achieve better quality in a services organization various methodology have been invented, tried and tested, implemented over the past few decades. These quality control and improvement methodologies have achieved varied levels of success with different organizations, i.e., while one methodology may have worked wonders in a particular organization at a point in time, it may have failed miserably in other organizations.

The success or failure of application of these methodologies comprises factor such as relevance to the organization, health of the processes, and involvement of the teams and maturity of quality practices in the organization. Selecting the right methodology is not easy given the fact that there are a plethora of quality methodologies which are available for adoption. Table 1 is a partial list of quality methodologies practiced by organizations. The list is so large that it becomes virtually impossible to adopt the right approach from the array of quality methodologies available for application. Whatever is adopted it should be a source of sustained value add to the organization.

TABLE 1
Various Quality Methodologies
Business Excellence Models

| | | |
|---|---|---|
| | EFQM | |
| Baldrige Excellence Model | Excellence Model | Deming Prize Criteria |

Standards

| | | |
|---|---|---|
| ISO 9000 Standards | BS 7799 | FS 9100 |
| TL 9000 | QS 9000 | ISO 14000 |
| CMM | COBIT | |

Quality Philosophies

| Business Process | Total Productive | |
|---|---|---|
| Re-engineering | Maintenance | SMED |
| Concurrent Engineering | Total Quality | Value Engineering |
| | Control | |
| Quality Costs | Total Quality | Pull System |
| | Management | |
| Statistical Quality Control | Value Stream | Benefit Cost Analysis |
| | Management | |
| Supplier Quality Assurance | Zero Defects | Process Management |
| Taguchi Method | Juran Trilogy | Theory of Constraints |
| Just in Time | QEDS Standards | Customer Relationship |
| | | Management |
| Kaizen | Quality Circles | Design of Experiments |
| Lean Manufacturing | Quality | Six Sigma (DMAIC) |
| | Management | |
| Poka Yoke | Hoshin Planning | Process Improvement |

(Refer: Annexure A for Definitions/Descriptions)

One embodiment of the invention overcomes the aforementioned drawbacks and provides a roadmap to an organization for achieving world class performance. One embodiment of the invention provides an improved quality framework that can be adopted in a service-driven industry. One embodiment of the invention determines the right mix of one or more quality methodologies that can be adopted by service organizations irrespective of the character of business activities of the organization. One embodiment of the invention provides a stepwise approach to move an organization up the improvement spiral by using various improvement methodologies and build a hierarchy of improvement systems. One embodiment of the invention provides an improved management architecture within which an organization's improvement system moves to a higher level of maturity so as to facilitate flawless delivery to the customer.

Embodiments of the present invention include an apparatus and method for continual improvement in an organization comprising the steps of classifying the stages of development of the organization into various levels in a hierarchy ranging from lower to higher, wherein the said classification is done by applying a plurality of attributes at each level, and applying one or more of known quality methodologies at each level wherein; for lower levels the methodologies selected aim at achieving desired physical improvements, for higher levels the combination of methodologies selected additionally aim at process improvements at that level, for the highest level the combination of methodologies selected aim at achieving customer satisfaction and reduction of defects, the said method moving from a lower to a higher level to increase the performance of the organization.

The organization may include business organization, government bodies, educational institutes, research laboratories or any domestic setup.

In one embodiment of the invention, the attributes at lower levels are used to define and measure physical workplace specifications whereas the attributes at higher levels are used for performance measurement.

According to one embodiment of the invention, attributes at the most basic level substantially include attributes to measure and avoid wastage for managing goods and services used or produced, attributes for prophylactically enquiring into problem causes for eliminating such problems, policies that define how the organization works and the procedures for implementing such policies, mechanism for receiving and implementing firm-wide suggestions for improvement from employees to facilitate their active participation, and attributes for assessing performance of workplace issues by conducting periodic meetings/reviews.

The higher levels substantially have attributes for standardization of all processes, identification of core processes in the organization, putting measurement of quality and delivery in each of said core processes, assessment of positive trending in measurement of said quality and delivery for said core processes, ascertaining the key vendors and putting measurement of quality, delivery, cost and service for the products and services of said key vendors, and assessment of positive trending and measurement of improvement in said quality, delivery, cost and service for said key vendor products and services.

The attributes at next higher level include (1) measurement of first pass yield, the said yield to be at least 90%; (2) measurement of on time delivery, the said delivery to be at least 95%, (3) measurement of quality cost, the said quality cost to be 10% of the processing cost, (4) measurement of process efficiency levels, the said proficiency levels to be at least 25%, and (5) score in a Business Excellence Model, the said score be at least 30%.

The attributes at the highest levels include (1) measurement of first pass yield, the said yield to be at least 99%; (2) measurement of on time delivery, the said delivery to be at least 99%; (3) measurement of quality cost, the said quality cost to be 5% of the processing cost, (4) measurement of process efficiency levels, the said proficiency levels to be at least 40%, (5) score in service satisfaction to be at least 95%; (6) and score in a Business Excellence Model, said score to be at least 60%.

The Business Excellence Model may include Malcolm Baldrige National Quality Award, European Foundation of Quality Management, Deming Prize, Australian Business Excellence Model etc.

The quality methodologies may include 5S, Business Process Management System, Six Sigma, Lean, TOC, TRIZ etc

In one embodiment, the classification of the stages of development of an organization can be done at four levels. The lower levels are a part of the higher levels which means Level 1 is a part of Level 2, Level 1 and Level 2 are a part of Level 3 and so on.

One embodiment of the instant invention further comprises a computer readable recording medium for storing a computer program to cause a computer to continually assess the improvement with organization and perform the steps of classifying stages of development/progress of the organization into various levels in a hierarchy ranging from lower to higher, wherein said classification is done by applying a plurality of attributes at each level, and applying one or more of known quality methodologies at each level wherein for lower levels, the methodologies selected aim at achieving desired physical improvements, for higher levels, the combination of methodologies selected, additionally aim at process improvements at that level, and for the highest level, the combination of methodologies selected aim at achieving customer satisfaction and reduction of defects, said method moving from a lower to a higher level to increase the quality level in the organization.

One embodiment of the instant invention further comprises a computer readable recording medium for storing data, the said data comprising structures for performing the steps including classifying the stages of development of the organization into various levels in a hierarchy ranging from lower to higher, wherein said classification is done by applying a plurality of attributes at each level, applying one or more of known quality methodologies at each level wherein for lower levels the methodologies selected, aim at achieving desired physical improvements; for higher levels the combination of methodologies selected, additionally aim at process improvements at that level; for the highest level the combination of methodologies selected aim at achieving customer satisfaction and reduction of defects, moving from a lower to a higher level to increase the performance levels of the organization.

One embodiment of the instant invention relates to an apparatus and method for creating a world-class organization, which can be adopted by any service-based industry/organizations/undertaking in the world. Around the globe, quality implementation in organizations has been centered on methodologies. Companies have traditionally adopted methodologies as ISO, BPR, Lean, Six Sigma, TOC, COPC, and CMM etc and have tried to get the best out of each one of them. The general approach has been that when the power of one methodology wanes, a new one is typically adopted. The above mentioned organization may include business organization, government bodies, educational institutes, research laboratories and a domestic setup as well.

One embodiment includes a method that builds quality in workplace, processes, customer experiences and businesses. It delivers the mission and vision of an organization to provide world-class quality in its product and service to the customers and delineate the steps to reach this end. The deliverables of each of the steps have been clearly defined and methodology application is based on the need and context. One feature of the method is that it builds on solid fundamental/foundations and gradually pushes the organization up the improvement spiral. The method provides a holistic script for quality adoption and can help to reach the end-goal in few years.

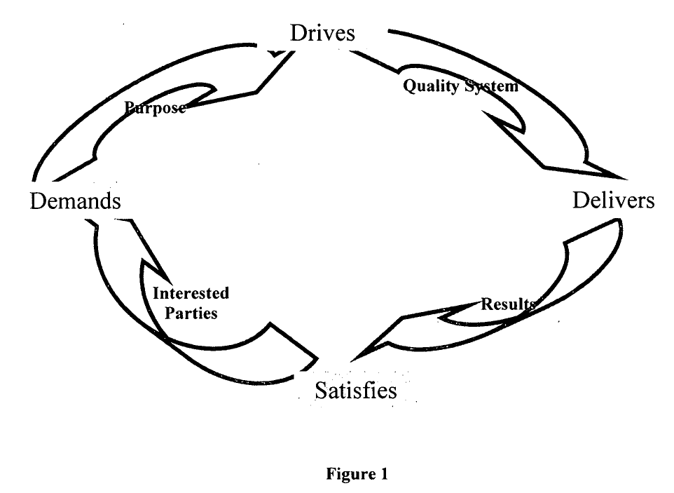

FIG. 1 is a diagram showing the relationship between the quality system and the stakeholders. All quality systems have a purpose that is generally dictated by its stakeholders. This purpose drives the systems, which delivers the results, which in turn satisfy the stakeholders.

One embodiment of the instant invention creates a hierarchy of systems within the organization. According to one embodiment of the invention, the development of any organization is divided into four levels. Each of the levels is a sub-system of a larger system, which is the next level. The premise here is that as the level of improvements mature in an organization, it gathers newer dimensions/elements to the existing systems and takes the organizations to higher levels of performance.

The systems are created in a hierarchy to let improvements grow organically. This also helps in delivering results continually to sustain the organization's interest in quality work. Each of the levels delivers specific results, which keeps the enthusiasm on towards the quality journey. This also helps improvement practitioners who are typically placed under enormous pressure to produce quick tangible results. One embodiment of the invention delivers value to the organization at regular interval. Without this, the motivation of employees may falter and they may start doubting the value from quality improvements.

The design is to gradually facilitate improvements by sequentially targeting on the following areas:
Physical Workplace
Processes
Waste Elimination
Excellence

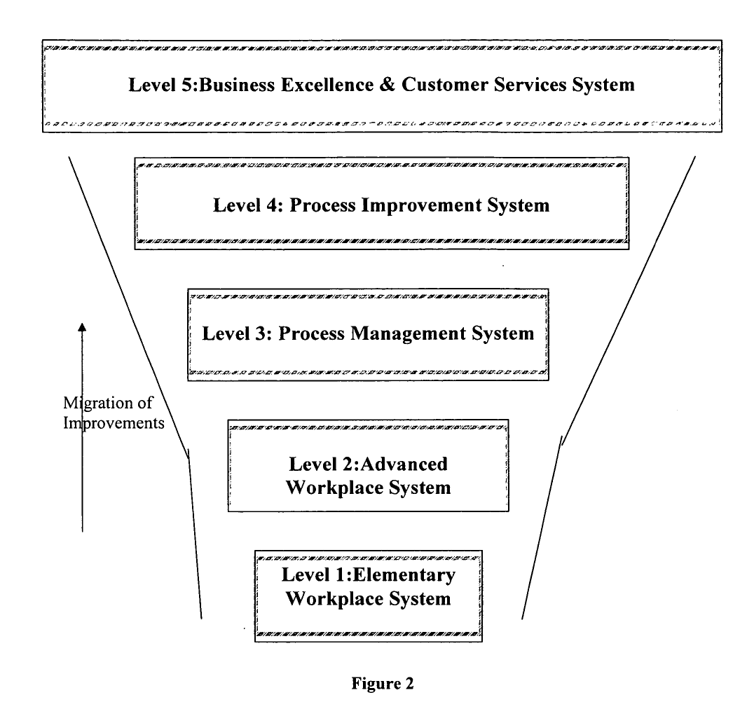

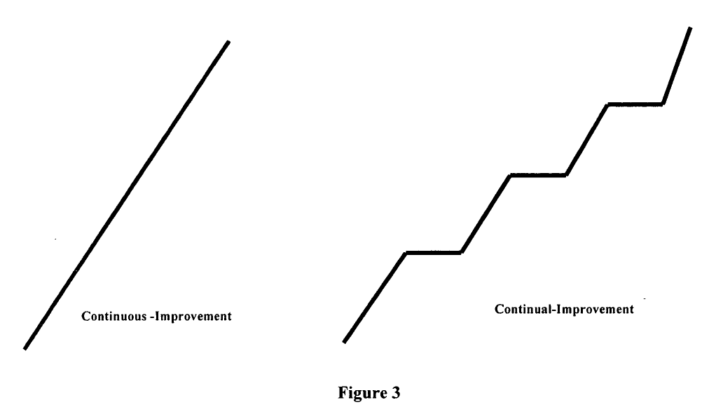

This requires creating systems around each of the above areas and integrating it. This results in creation of a quality system funnel along which improvements migrate up. This concept is shown in FIG. 2. FIG. 2 is an overview of one embodiment of the invention. It is evident from the figure that the quality systems at each level is a super-system of the preceding system. So level 2 is a super-system for level 1, level 3 is a super-system for level 2, level 4 is a super-system for level 3. Conversely, each of the levels is a sub-system of the next/immediate succeeding quality system. So, level 1 is a sub-system of level 2, level 2 is a sub-system for level 3; level 3 is a sub-system for level 4.

An organization has to rise from a lower level to a higher level to achieve the desired standard. Each level mentioned above has unique attributes, which are considered to decide whether the organization has reached a particular level.

The levels and the attributes to be considered at each of the levels are as follows:

Level 1

Broad Objectives

In one embodiment, the broad objectives of Level I include as follows:
Create efficient workplaces.
Build a “own your workplace” mindset and eliminate Orphans.
Involve bulk of the organization in the quality journey.
Facilitate a culture wherein teams get into root causes for workplace problems.
Install policies, procedures, standards and rules, that can sustain workplace organization.
Eliminate surface wastes.
Aid quick information retrieval.

In one embodiment, the attributes at this level include:
Measurements to avoid wastage for managing goods and services used or produced. This is basically the inventory management of the organization. It takes care of the products or services used or consumed within the organization, so that there is minimal wastage.,
Attributes for prophylactically enquiring into problem causes, for eliminating such problems. This takes care that any problems is solved to the root. The problem may concern any issue in the organization. This is also taken care of by distributing responsibilities.
Policies that define how the organization works and the procedures for implementing such policies.
Mechanism for receiving and implementing suggestions for improvement from employees to facilitate participation.
Attributes for assessing performance of workplace issues by conducting periodic meetings.
   Level 2

Level 2 is about building a robust quality management system in a workplace. Process management and improvement has to be carried out with the overall system performance in mind. The level requires putting in place right measurements comprising lag and lead indicators, which track actual results as well as help in predicting the results.

Other than Processes, the elements of Level 2 include leadership, continual Improvement, training, vendors, quality audits and analysis of results. It requires clear identification of core-processes and how it helps in achieving the strategic objectives of the Business Units.

In one embodiment, the broad objectives of Level 2 include as follows:
Uniform customer experience.
Define best-known method (standard process) to carry out tasks in a workplace.
Help the un-initiated to do their jobs easily.
Facilitate standardization of repeated tasks in a workplace (processes).
Install Measurements and Ownership to manage processes on an ongoing basis.
Promote systems thinking (Understand Interaction and Interdependencies of processes).
Build an architecture which allows continual improvement.
Install processes in areas where traditionally it has not been used (as sales).
Avoid local optimization at the cost of system optimization.

In one embodiment, the elements of level 2 include as follows:
Institutionalization (Management Commitment).
Process Management.
Continual improvement.
Quality training.
Data and results.

The attributes at this level includes:
standardization of all processes,
identification of core processes in the organization,
putting measurement of quality and delivery in each of said core processes,
positive trending in measurement of said quality and delivery for said core processes,
ascertaining the key vendors and putting measurement of quality, delivery, cost and service for the products and services of said key vendors, and
positive trending and measurement of improvement in said quality, delivery, cost and service for said key vendor products and services.
   The key vendors mentioned above include vendors providing the key and the core processes as well as the products.
   Level 3

Level 3 is about taking the organization to higher levels of quality maturity by accomplishing items such as the following:
(1) Making processes effective by taking process improvement projects in proactive fashion
(2) Removing wastes in all form and
(3) Commence tracking cost of poor quality (Quality Costs) on an ongoing basis
(4) Involving participation of teams in workplaces in carrying out improvements on an ongoing basis

Making processes effective means key processes are delivering an agreed acceptable quality levels (read: Sigma Levels). This would mean we would radically reduce the negative customer experiences by taking proactive steps to improve performance of processes.

While making processes effective, we have to work towards eliminating the unseen wastes in our workplaces. This comprises wastes due to: overproduction, excess inventory, transportation, waiting, motion, over-processing, correction, complexity and bureaucracy.

While wastes get removed and processes become effective, we will be measure the benefits to company by tracking the cost of poor quality levels.

All these would be possible when teams in the workplace or process owners participate in the movement. Teams in workplaces should not only own up the initiative but also take up projects, which help in elimination of wastes and process effectiveness.

In one embodiment, attributes at this level include:
Quality, which is a measure to ascertain the quality of output delivered by a process. It could include things elements such as completeness, accuracy, defects and so on. This attribute takes care that first pass yield will be more 90%
Delivery, which is a measure of lead time of a process. A high lead time indicates process bottlenecks, which may be impeding the process flow. Delivery Lead times should be more 95%
Cost, which is a measure to ascertain the cost effectiveness of a process. It endeavors to find out the costs incurred for not producing a product or service right first time. Quality cost to be 10% of the processing cost
Process Efficiency Levels which should be more than 25%
Score in any known Business Excellence Model to be at least 30%.
   Level 4

This is the next and final stage of the development. A Level 4 workplace has processes, which are effective and efficient. They should not only deliver what the customer wants but should do so in the most cost efficient manner. The business should have minimal hidden factories and should have installed all the elements of a Business Excellence Models such as Malcolm Baldrige or European Quality Award. The application of Business Excellence models will enable to track a Business with respect to elements as Leadership, Strategic Planning, Customers, Human Resources, Process Management, and Business Results.

The focus of level 4 is also on customer interaction. All the customer experiences have to be blueprinted and pro-active steps have to be taken at the potential failure points. Critical control points can be installed all across to constantly gauge the service levels being provided by us. Reaching this level would require the marriage of flawless back-end processes and robust customer interaction processes. Customer needs cannot be fully met completely and economically. Operational efficiency has to be balanced against effectiveness of the system from the customer's point of view.

In one embodiment, the objectives of level 4 include as follows:
Install all elements that facilitate business excellence.
Focus on performance excellence for the entire organization in an overall management system around elements as leadership, strategic planning, customers, human resources, process management and business results.
Provide Service Guarantee to the customer (pay if we fail to deliver).
Bulk of the process within a business unit are efficient and effective.

In one embodiment, the attributes at this level include:

Quality

First pass yield will be more 99%.

Delivery

Delivery Lead Times will be more 99%.

Cost

Quality cost to be 5% of the processing cost.

Efficiency Levels

Process Efficiency levels to be more than 40%.

Service

This is a measure of service effectiveness of a process and finds out the quality of interaction between the people involved in the process and the customer of the process. It measures elements as courtesy, empathy, responsiveness, access, credibility, and communication. Service Satisfaction score will be more than 95%.

In one embodiment, the score in any Business Excellence Model is at least 60% The Business Excellence Model mentioned above includes any such known model such as the Malcolm Baldrige Excellence, Deming Prize, and European Foundation of Quality Management and so on.

Underlying Theme of Business Transformation Model

An underlying theme which runs through the Business Transformation Model is continual improvement. This is about sustaining the gains and constantly raising the quality bar. This is illustrated in FIG: 3.

Improvement specialists often synonymously use the terms “continuous-impruvement” and “continual-improvement.” However, they are not the same in the context of embodiments of the invention described herein.

Continuous-improvement is about constantly carrying out improvements without giving time for sustaining benefits. The quality bar is constantly raised without necessarily allowing the benefits to seep in. This results in the benefits sliding back after sometime without the organization coming to know of it.

Continual-Improvement is about carrying out improvements, giving sufficient time for sustaining the benefits and then moving on to the next level. The advantage here is that the improvements that have been carried out get sufficient time to seep deep and within the organization. An architecture for sustenance is proactively installed to institutionalize and sustain the benefits as the organization moves up the improvement spiral up the next Level. The major advantage of this approach is that sustained improvement becomes self-sustaining. There is sufficient time to change the behavior of employees due to improvements, which is a requirement of all quality journeys.

PDCA and Business Transformation Model

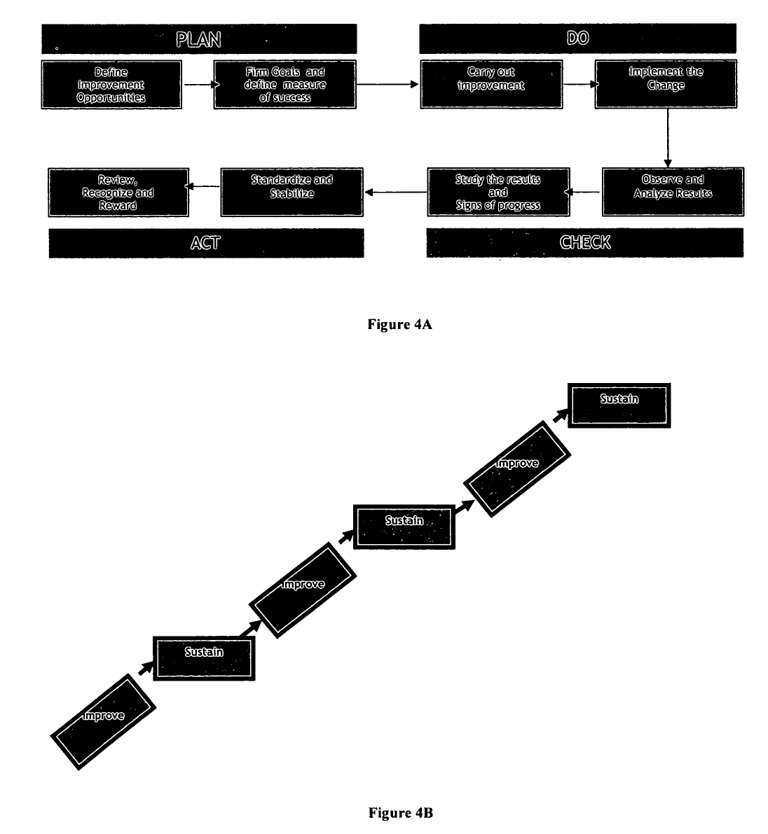

FIG. 4A shows the PDCA cycle proposed by William Edward Deming. PDCA stands for Plan-Do-Check-Act. This philosophy of PDCA is that continuation of four steps (of Plan, Do, Check and Act) leads to a helix of continual improvement. PDCA cycle is a never-ending cycle of learning and improvement that Deming developed, based on what he learned from his mentor, Walter Shewhart. Deming taught it to the Japanese in the 1950. He called “the Shewhart Cycle” and the Japanese call it: “the Deming Wheel”.

The above defined levels in one embodiment of the instant invention are designed on the principles of PDCA cycle. It endeavors to create an improvement spiral, which pushes an organization towards World Class. In one embodiment, it is applied as follows:

Plan=

Define the Improvement Opportunities.
Firm up goals and define how success will be measured.
   Do=
Carry out improvements as planned
Implement the change
Use Quality Methodology and Interventions
   Check=
Observe and Analyze Results
Study the results and signs of progress
   Act=
Standardize and stabilize the change
Review, Recognize and Reward
Re-establish the target and Begin the cycle again

FIG. 4A shows the above pictorially. FIG. 4B shows the PDCA cycle coupled with the continual improvement ladder.

Furthermore like any product or service, all quality methodologies have a lifecycle. Understanding the lifecycle is critical for sustenance of improvements in an organization. An organization cannot reach world class just by adopting one quality methodology. It can only be achieved by enmeshing and leveraging the power of various quality methodologies.

Keeping the above points in mind, one embodiment of the invention divides the development of an organization into the four levels of gradual and seamless improvement described above. After analyzing the state/status of an organization in terms of the attributes of the level where the organization currently stands, it is decided whether the organization needs to work more on such attributes or has it reached the desired state. The standard value of the attributes and the present readings of the attributes can be stored on any computer readable medium for records and ready reference. To achieve a particular level, according to readings of the attributes, one embodiment of the instant invention provides a suitable mix quality methodologies.

One embodiment includes an apparatus that comprises a means to divide the stages development of an organization into four levels on the basis of the attributes and means to provide an appropriate combination of the methodologies on the basis of said attributes. In a preferred embodiment, the above apparatus may be any computing or non-computing device. In another embodiment, the instant invention may be a Business Transformation Model.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meanings and range of equivalency of the claims are to be embraced within their scope.

What is claimed is:

1. A method of improving an organization, said method comprising:
classifying an organization into at least one of a plurality of levels in a hierarchy ranging from lower to higher, wherein said classifying includes measuring the organization against a plurality of attributes at each level,
applying one or more of known quality methodologies at each level wherein:
for at least one lower level, the methodologies selected, aim at achieving desired physical improvements,
for at least one level that is higher than the lower level, the combination of methodologies selected, additionally aim at process improvements,
for the highest level, the combination of methodologies selected aim at achieving customer satisfaction and reduction of defects,
wherein applying comprising determining whether the company meets the attributes of the classified level prior to progressing the company to a higher level.

2. The method as claimed in claim 1, wherein the organization includes business organizations, government bodies, educational institutes, research laboratories.

3. The method as claimed in claim 1, wherein the attributes at lower levels are used to define and measure the physical workplace specifications.

4. The method as claimed in claim 1, wherein the attributes at higher levels are used for performance measurement.

5. The method as claimed in claim 3, wherein said attributes for at least one level include:
attributes for measuring and avoiding wastage for managing goods and services used or produced,
attributes for identifying problem causes,
policies that define how the organization works and the procedures for implementing such policies,
mechanism for receiving and implementing suggestions for improvement from employees to facilitate their active involvement, and
attributes for assessing performance of workplace issues by conducting periodic meetings and reviews.

6. The method as claimed in claim 4, wherein at least one levels, includes attributes for:
standardization of all processes,
identification of core processes in the organization,
measuring quality and delivery in each of said core processes,
positive trending in measurement of said quality and delivery for said core processes,
ascertaining the vendors and measuring the quality, delivery, cost and service for the products and services of said vendors, and
positive trending and measuring improvement in said quality, delivery, cost and service for said vendor products and services.

7. The method as claimed in claim 1, wherein the attributes of one of the levels include:
measurement of first pass yield, said yield to be at least 90%,
measurement of on time delivery, said delivery to be at least 95%,
measurement of quality cost, said quality cost to be 10% of the processing cost,
measurement of process efficiency levels, said proficiency levels be at least 25%, and
score in a Business Excellence Model, said score to be at least 30%.

8. The method as claimed in claim 1, wherein the attributes at the highest level includes:
measurement of first pass yield, said yield to be at least 99%,
measurement of on time delivery, said delivery to be at least 99%,
measurement of quality cost, said quality cost be 5% of the processing cost,
measurement of process efficiency levels, said proficiency levels be at least 40%,
score in service satisfaction, said score be at least 95%, and
score in a Business Excellence Model, said score be at least 60%.

9. The method of claim 7, wherein said business excellence model includes: Malcolm Baldrige National Quality Award, European Foundation of Quality Management, Deming Prize, and an Australian Business Excellence Model.

10. The method of claim 1, wherein the attributes for a selected level are a subset of the attributes of a higher level.

11. The method as claimed in claim 1, wherein said quality methodologies include 5S, ISO certifications, Six Sigma, Lean, theory of constraints, and total quality management (TQM), Process Management System, and Theory of Constraints.

12. The method as claimed in claim 1, wherein said classification is done at four levels.

13. An apparatus for improving an organization, the apparatus comprising:
means for classifying an organization into at least one of a plurality of levels in a hierarchy ranging from lower to higher, wherein said classifying includes measuring the organization against a plurality of attributes at each level; and
means for applying one or more of known quality methodologies at each level wherein:
for at least one lower level, the methodologies selected, aim at achieving desired physical improvements,
for at least one level that is higher than the lower level, the combination of methodologies selected, additionally aim at process improvements at that level,
for the highest level, the combination of methodologies selected aim at achieving customer satisfaction and reduction of defects,
wherein the means for applying determines whether the company meets the attributes of the classified level prior to progressing the company to a higher level.

14. The apparatus as claimed in claim 13, wherein said classifying means classifies the stages of development of the organization into four levels.

15. A program storage device storing instructions that when executed performs the method comprising:
classifying an organization into at least one of a plurality of levels in a hierarchy ranging from lower to higher, wherein said classifying includes measuring the organization against a plurality of attributes at each level,
applying one or more of known quality methodologies at each level wherein:
for at least one lower level, the methodologies selected, aim at achieving desired physical improvements,
for at least one level that is higher than the lower level, the combination of methodologies selected, additionally aim at process improvements at that level,
for the highest level, the combination of methodologies selected aim at achieving customer satisfaction and reduction of defects; and
wherein applying comprising determining whether the company meets the attributes of the classified level prior to progressing the company to a higher level.
